(19) United States
(12) Patent Application Publication
(10) Pub. No.: US 2018/0339491 A1
(43) Pub. Date: Nov. 29, 2018

(54) INSULATION FOR MODULAR BUILDINGS

(71) Applicant: Zephyros, Inc., Romeo, MI (US)

(72) Inventors: Eren Hursit, Birmingham, MI (US); Kendall Bush, Macomb, MI (US)

(21) Appl. No.: 15/988,256

(22) Filed: May 24, 2018

Related U.S. Application Data
(60) Provisional application No. 62/510,517, filed on May 24, 2017.

(51) Int. Cl. B32B 5/32; E04B 1/88; E04B 1/76; B32B 19/06; B32B 17/06; D04H 1/593; D04H 5/04

(52) U.S. Cl. CPC B32B 5/32; E04B 1/88; E04B 1/7658; B32B 19/06; B32B 17/067; D04H 1/593; B32B 2255/205; B32B 2307/102; B32B 2307/304; B32B 2307/306; B32B 2307/752; B32B 2250/03; B32B 2255/02; D04H 5/04

(57) ABSTRACT

An article including one or more foam material layers and one or more nonwoven fibrous layers. The article is adapted to be used as insulation within a wall or hollow cavity. The article is a material that is acoustically and thermally functional, thermally insulative, easy to handle and fabricate, easy to slide into wall channels or place into wall, light weight, non-shedding, non-toxic, no mold/mildew, continuous (longer lengths in one piece), resistant to tearing/breaking, that has a high R-value, or a combination thereof.

### FIELD

The present teachings relate generally to insulation materials, and more particularly, to insulation materials for buildings, such as within walls or wall channels.

### BACKGROUND

During construction of buildings, such as residential or commercial buildings, insulation is used within or between parts of a wall. The insulation is used for maintaining a desired temperature within the building, such as to reduce the escape of heat during cooler months or to keep heat from entering the building or keep air conditioning from escaping during warmer months.

Traditional materials, such as fiberglass insulation, have been employed as a residential and commercial insulator. While it acts as an efficient insulator, there are health risks with exposure to fiberglass insulation. When fiberglass insulation is disturbed, it releases particles into the air. Particles of fiberglass insulation are dangerous to inhale, which can cause respiratory problems and nosebleeds. Contact of particles of fiberglass with skin can cause rashes and irritation. It is recommended that gloves, long-sleeved shirts, long pants, eye protection, and a respirator be worn when installing or removing fiberglass insulation to reduce or prevent contact with particles of fiberglass insulation.

Foam materials are also used to act as insulators. However, these foam materials are often brittle and easily damaged. Foam boards are only available in incremented thicknesses, as well, thereby making it difficult to customize the foam used. In addition, foam materials may allow for moisture to be trapped within its pores, thereby allowing for mold and/or mildew to grow.

It is therefore desired to provide an insulation material that is safe to handle, non-toxic, and non-shedding. It is also desired to provide an insulation material that provides a high R-value, an insulation material that is acoustically functional, or both. It is desirable to provide an insulation material that is easy to fabricate, easy to handle, easy to slide into wall channels or place into a wall. It is desirable that the insulation material is light weight, yet durable, so it resists tearing or breaking.

### SUMMARY

The present teachings meet one or more of the above needs by the improved devices and methods described herein. The present teachings provide an article comprising: one or more foam material layers and one or more nonwoven fibrous layers. The article is adapted for use as insulation within a wall or hollow cavity. The article is a material that is acoustically functional, easy to handle and fabricate, easy to slide into wall channels or place into wall, light weight, non-shedding, non-toxic, no mold/mildew, continuous (longer lengths in one piece), resistant to tearing/breaking, that has a high R-value, or a combination thereof.

The article may include any combination of the following features: the one or more foam material layers may be sandwiched between two nonwoven fibrous layers; the one or more nonwoven fibrous layers may be sandwiched between two foam material layers; the article may exhibit an R-value of about 12° F.·ft²·h/Btu or greater at a thickness of about 60 mm to about 70 mm; the one or more fibrous layers may be adapted to provide protection to the one or more foam material layers; the one or more fibrous layers may be compressible to fit within the wall or hollow cavity; the article may be mold or mildew resistant; the article may be non-shedding; the article may be non-toxic; the article or one or more layers thereof may be thermoformable; the foam material layer may be formed of a polyisocyanurate (PIR) board; the foam material layer may be formed via a foam-in-place process after being applied to one or more of the fibrous layers; the article may be drilled without breaking so that holes can be made within the article; the nonwoven fibrous layer may include fibers selected from polyester (PET), polyacrylonitrile (PAN), oxidized polyacrylonitrile (Ox-PAN, OPAN, or PANOX), aramid, olefin, polyamide, imide, polyetherketone (PEK), polyetheretherketone (PEEK), Poly(ethylene succinate), polyether sulfonate (PES), mineral, ceramic, natural or another polymeric fiber; the fibrous layer may include bicomponent fibers; the fibrous layer may be formed by distributing fibers via an air laying process, carding process, lapping process, or combination thereof; the fibrous layer may include one or more additives selected from recycled waste, virgin (non-recycled) materials, binders, fillers (e.g., mineral fillers), adhesives, powders, thermoset resins, coloring agents, flame retardants, and longer staple fibers; the article may include one or more fasteners for securing the article within an area to be insulated, or for holding the article in a desired shape; the article may include one or more adhesives for securing the article within an area to be insulated, or for holding the article in a desired shape; the article may be fire and/or smoke retardant (to comply with building codes).

The present teachings, therefore, provide a thermal insulation material with a high R-value that is acoustically functional, easy to handle and fabricate, easy to slide into wall channels or place into a wall, light weight, non-shedding, non-toxic, without mold or mildew, that resists tearing and/or breaking, or a combination thereof.

### DESCRIPTION OF THE DRAWINGS

FIG. 1 is a cross-sectional view of an insulator in accordance with the present teachings.

FIG. 2 is a cross-sectional view of an insulator in accordance with the present teachings.

FIG. 3 is a cross-sectional view of an insulator in accordance with the present teachings.

FIG. 4 is a cross-sectional view of an insulator in accordance with the present teachings.

FIG. 5 is a cross-sectional view of a clamshell-type structure having insulation material located within a hollow cavity in accordance with the present teachings.

### DETAILED DESCRIPTION

The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the description herein, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

Insulation materials, such as insulation materials, may have a wide range of applications, such as in building materials, automotive applications, generator set engine compartments, commercial vehicle engines, in-cab areas, construction equipment, agriculture equipment, architectural applications, flooring, floormat underlayments, and even heating, ventilating and air conditioning (HVAC) applications. Insulation materials may be used for machinery and equipment insulation, motor vehicle insulation, domestic appliance insulation, dishwashers, and commercial wall and ceiling panels. Insulation materials may be used to be inserted into hollow channels, walls or structures, such as to provide acoustic damping, thermal insulation, or both. These insulation materials may be used in construction and/or within modular building systems. Insulation material may be used in an engine cavity of a vehicle, on the inner and/or outer dash panels, or under the carpeting in the cabin, for example. Insulation materials may also provide other benefits, such as sound absorption, compression resiliency, stiffness, structural properties, and protection (e.g., to an item around which the insulation material is located). The insulation material may also serve as a sound attenuation material in a wall of a building or vehicle, attenuating sound originating from one side of the wall to the other.

The present teachings envision the use of an insulator including one or more fibrous layers for providing insulation. The insulator may include one or more foam material layers. The layers may be attached to each other by one or more lamination processes, one or more adhesives, one or more in-situ foaming processes, or a combination thereof. One measurement of insulation materials is the R-value, which is a measure of thermal resistance through the material. The higher the R-value, the more a material prevents heat transfer.

The insulator of the present teachings may include one or more foam layers. The foam layers may provide structure or rigidity to the insulator, may provide thermal insulation for the insulator, may provide acoustic absorption, or a combination thereof. The foam material may be formed of a polymeric material. The foam may be a thermoset plastic material. The foam material may be made of polyurethane (PUR), polyisocyanurate (PIR), or a combination thereof. The one or more foam layers may be formed from a foam board that is able to be shaped (e.g., via cutting). The foam layer may be formed through an in-situ foaming process, such as by exposure of the material to heat or gas, such as carbon dioxide or hydrofluorocarbon (HFC) gas.

The foam material layer may have dimensions that allow the material to be fit within the space to which it is to be installed. For example, if the insulation material is to be slid into a cavity, the foam material must be able to fit within this area. The foam may have a finished thickness of about 10 mm or more, about 20 mm or more, or about 50 mm or more. The foam may have a finished thickness of about 100 mm or less, about 80 mm or less, or about 65 mm or less. The foam may have an R-value (F·ft²·h/Btu) of about 5 or more, about 6 or more, about 10 or more. The foam may have an R-value of about 25 or less, about 20 or less, or about 18 or less.

The insulator may include one or more fibrous layers. The fibrous layers may enhance insulation, sound absorption, structural properties, protection for the foam material layer, or a combination thereof. One or more fibrous layers may include a facing layer or a scrim. One or more of the fibrous layers may have a high loft (or thickness) at least in part due to the orientation of the fibers (e.g., oriented generally transverse to the longitudinal axis of the layer) of the layer and/or the methods of forming the layer. The fibrous layer may exhibit good resilience and/or compression resistance. The fibrous layer may be able to be compressed to fit within a cavity or wall structure. The fibrous layers, due to factors such as, but not limited to, unique fibers, facings, physical modifications to the three-dimensional structure (e.g., via processing), orientation of fibers, or a combination thereof, may exhibit good thermal insulation capabilities versus traditional insulation materials.

The fibrous layers may function to provide insulation, acoustic absorption, structural support and/or protection to the one or more foam material layers or to the structure into which the insulator is to be positioned or inserted. The fibrous layers may be adjusted based on the desired properties. The fibrous layers may be tuned to provide a desired weight, thickness, compression resistance, or other physical attributes. The fibrous layers may be tuned to provide a desired thermal conductivity. The fibrous layers may be formed from nonwoven fibers. The fibrous layers may be a nonwoven structure. The fibrous layers may be a lofted material. The fibrous layers may be thermoformable so that they layers may be molded or otherwise shaped to fit within a channel or hollow cavity of the structure to be insulated and/or reinforced.

The fibers that make up the fibrous layers may have an average linear mass density of about 0.5 denier or greater, about 1 denier or greater, or about 5 denier or greater. The material fibers that make up the fibrous layer may have an average linear mass density of about 25 denier or less, about 20 denier or less, or about 15 denier or less. Fibers may be chosen based on considerations such as cost, resiliency, desired thermal conductivity, or the like. For example, a coarser blend of fibers (e.g., a blend of fibers having an average denier of about 12 denier) may help provide resiliency to the fibrous layer. A finer blend may be used, for example, if thermal conductivity is desired to be further controlled. The fibers may have a staple length of about 1.5 millimeters or greater, or even up to about 70 millimeters or greater (e.g., for carded fibrous webs). For example, the length of the fibers may be between about 30 millimeters and about 65 millimeters. The fibers may have an average or common length of about 50 to 60 millimeters staple length, or any length typical of those used in fiber carding processes. Short fibers may be used (e.g., alone or in combination with other fibers) in any nonwoven processes, such as the formation of air laid fibrous webs. For example, some or all of the fibers may be a powder-like consistency (e.g., with a fiber length of about 2 millimeters to about 3 millimeters, or even smaller, such as about 200 microns or greater or about 500 microns or greater). Fibers of differing lengths may be combined to provide desired insulation and/or acoustic properties. The fiber length may vary depending on the application; the insulation properties desired; the acoustic properties desired; the type, dimensions and/or properties of the fibrous material (e.g., density, porosity, desired air flow resistance, thickness, size, shape, and the like of the fibrous layer and/or any other layers of the insulation material); or any combination thereof. The addition of shorter fibers, alone or in combination with longer fibers, may provide for more effective packing of the fibers, which may allow pore size to be more readily controlled in order to achieve desirable characteristics (e.g., acoustic and/or insulation characteristics).

The fibers forming the fibrous layers may be natural or synthetic fibers. Suitable natural fibers may include cotton, jute, wool, cellulose, glass, and ceramic fibers. Suitable synthetic fibers may include polyester, polypropylene, polyethylene, Nylon, aramid, imide, acrylate fibers, or combination thereof. The fibrous layer material may comprise polyester fibers, such as polyethylene terephthalate (PET), and co-polyester/polyester (CoPET/PET) adhesive bi-component fibers. The fibers may include polyacrylonitrile (PAN), oxidized polyacrylonitrile (Ox-PAN, OPAN, or PANOX), olefin, polyamide, polyetherketone (PEK), polyetheretherketone (PEEK), poly(ethylene succinate), polyether sulfonate (PES), or other polymeric fibers. The fibers may include mineral or ceramic fibers. The fibers may be formed of any material that is capable of being carded and lapped into a three-dimensional structure. The fibers may be 100% virgin fibers, or may contain fibers regenerated from postconsumer waste (for example, up to about 90% fibers regenerated from postconsumer waste or even up to 100% fibers regenerated from postconsumer waste). The fibers may have or may provide improved thermal insulation properties. The fibers may have relatively low thermal conductivity. The fibers may have geometries that are non-circular or non-cylindrical to alter convective flows around the fiber to reduce convective heat transfer effects within the three-dimensional structure. The fibrous layer may include or contain engineered aerogel structures to impart additional thermal insulating benefits.

The fibers, or at least a portion of the fibers, may have high infrared reflectance or low emissivity. At least some of the fibers may be metallized to provide infrared (IR) radiant heat reflection. To provide heat reflective properties to and/or protect the fibrous layer, the fibers may be metalized. For example, fibers may be aluminized. The fibers themselves may be infrared reflective (e.g., so that an additional metallization or aluminization step may not be necessary). Metallization or aluminization processes can be performed by depositing metal atoms onto the fibers. As an example, aluminization may be established by applying a layer of aluminum atoms to the surface of fibers. Metalizing may be performed prior to the application of any additional layers to the fibrous layers.

The metallization may provide a desired reflectivity or emissivity. The metallized fibers may be about 50% IR reflective or more, about 65% IR reflective or more, or about 80% IR reflective or more. The metallized fibers may be about 100% IR reflective or less, about 99% IR reflective or less, or about 98% IR reflective or less. For example, the emissivity range may be about 0.01 or more or about 0.20 or less, or 99% to about 80% IR reflective, respectively. Emissivity may change over time as oil, dirt, degradation, and the like may impact the fibers in the application.

Other coatings may be applied to the fibers, metallized or not, to achieve desired properties. Oleophobic and/or hydrophobic treatments may be added. Flame retardants may be added. A corrosion resistant coating may be applied to the metalized fibers to reduce or protect the metal (e.g., aluminum) from oxidizing and/or losing reflectivity. IR reflective coatings not based on metallization technology may be added.

One or more fibrous layers may include a plurality of bi-component fibers. The bi-component fibers may be a thermoplastic lower melt bi-component fiber. The bi-component fibers may have a lower melting temperature than the other fibers within the mixture (e.g., a lower melting temperature than common or staple fibers). The bi-component fibers may be air laid or mechanically carded, lapped, and fused in space as a network so that the material may have structure and body and can be handled, laminated, fabricated, installed as a cut or molded part, or the like to provide insulation properties, acoustic absorption, or both. The bi-component fibers may include a core material and a sheath material around the core material. The sheath material may have a lower melting point than the core material. The web of fibrous material may be formed, at least in part, by heating the material to a temperature to soften the sheath material of at least some of the bi-component fibers. The temperature to which the fibrous layer (or other layer of the insulation material) is heated to soften the sheath material of the bi-component may depend upon the physical properties of the sheath material. For a polyethylene or polypropylene sheath, the temperature may be about 140 degrees C. or greater, about 150 degrees C. or greater, or about 160 degrees C. or greater. The temperature may be about 220 degrees C. or less, about 210 degrees C. or less, or about 200 degrees C. or less. Bi-component fibers having a polyethylene terephthalate (PET) sheath or a polybutylene terephthalate (PBT) sheath, for example, may melt at about 180 degrees C. to about 200 degrees C. The bi-component fibers may be formed of short lengths chopped from extruded bi-component fibers. The bi-component fibers may have a sheath-to-core ratio (in cross-sectional area) of about 15% or more, about 20% or more, or about 25% or more. The bi-component fibers may have a sheath-to-core ratio of about 50% or less, about 40% or less, or about 35% or less.

The fibers of the one or more fibrous layers may be blended or otherwise combined with suitable additives such as other forms of recycled waste, virgin (non-recycled) materials, binders, fillers (e.g., mineral fillers), adhesives, powders, thermoset resins, coloring agents, flame retardants, longer staple fibers, etc., without limitation. Any, a portion, or all of the fibers used could be of the low flame and/or smoke emitting type (e.g., for compliance with flame and smoke standards for transportation).

In some applications, the use of shorter fibers may have advantages for forming an insulation material that may also exhibit acoustic absorption properties. The selected air flow resistivity achieved using short fibers may be significantly higher than the air flow resistivity of a conventional nonwoven material comprising substantially only conventional staple fibers having a long length of, for example, from at least about 30 mm and less than about 100 mm. Without being limited by theory, it is believed that this unexpected increase in air flow resistance may be attained as a result of the short fibers being able to pack more efficiently (e.g., more densely) in the nonwoven material than long fibers. The shorter length may reduce the degree of disorder in the packing of the fibers as they are dispersed onto a surface, such as a conveyor, or into a preformed web during production. The more ordered packing of the fibers in the material may in turn lead to an increase in the air flow resistivity. In particular, the improvement in fiber packing may achieve a reduced interstitial space in between fibers of the nonwoven material to create a labyrinthine structure that forms a tortuous path for air flow through the material, thus providing a selected air flow resistance, and/or selected air flow resistivity. Accordingly, it may be possible to produce comparatively lightweight nonwoven materials without unacceptably sacrificing performance.

The fibers forming the one or more fibrous layers may be formed into a nonwoven web using nonwoven processes including, for example, blending fibers, carding, lapping, air laying, mechanical formation, or a combination thereof. Through these processes, the fibers may be oriented in a generally vertical direction or near-vertical direction (e.g., in a direction generally perpendicular to the longitudinal axis of the fibrous layer). The fibers may be opened and blended using conventional processes. The resulting structure formed may be a lofted fibrous layer. The lofted fibrous layer may be engineered for optimum weight, thickness, physical attributes, thermal conductivity, insulation properties, acoustic absorption, or a combination thereof.

One or more fiber layers may be formed, at least in part, through a carding process. The carding process may separate tufts of material into individual fibers. During the carding process, the fibers may be aligned in substantially parallel orientation with each other and a carding machine may be used to produce the web.

A carded web may undergo a lapping process to produce the fibrous layers. The carded web may be rotary lapped, cross-lapped or vertically lapped, to form a voluminous or lofted nonwoven material. The carded web may be vertically lapped according to processes such as “Struto” or “V-Lap”, for example. This construction provides a web with relative high structural integrity in the direction of the thickness of the fibrous layer, thereby minimizing the probability of the web falling apart during application, or in use, and/or providing compression resistance to the insulation material when it is installed around the item to be insulated. Carding and lapping processes may create a nonwoven fiber layer that has good compression resistance through the vertical cross-section (e.g., through the thickness of the material) and may enable the production of a lower mass fibrous layer, especially with lofting to a higher thickness without adding significant amounts of fiber to the matrix. It is contemplated that a small amount of hollow conjugate fiber (i.e., in a small percentage) may improve lofting capability and resiliency to improve insulation, sound absorption, or both. Such an arrangement also provides the ability to achieve a low density web with a relatively low bulk density.

The fibrous layer may be formed by an air laying process. This air laying process may be employed instead of carding and/or lapping. In an air laying process, fibers are dispersed into a fast moving air stream, and the fibers are then deposited from a suspended state onto a perforated screen to form a web. The deposition of the fibers may be performed by means of pressure or vacuum, for example. An air laid or mechanically formed web may be produced. The web may then be thermally bonded, air bonded, mechanically consolidated, the like, or combination thereof, to form a cohesive nonwoven insulation material. While air laying processes may provide a generally random orientation of fibers, there may be some fibers having an orientation that is generally in the vertical direction so that resiliency in the thickness direction of the material may be achieved.

One or more fibrous layers may be formed to have a desired thickness that provides a desired R-value. The one or more fibrous layers may have a thickness of about 2 mm or more, about 5 mm or more, or about 7 mm or more. The one or more fibrous layers may have a thickness of about 30 mm or less, about 25 mm or less, or about 20 mm or less. The layers may be compressed to fit within the space to which the insulation is to be installed. Each layer may have an R-value (F·ft²·h/Btu) of about 0.5 or greater, about 1 or greater, or about 1.5 or greater. Each layer may have an R-value of about 10 or less, about 7 or less, or about 4 or less.

One or more fibrous layers, the fibers forming the fibrous layers, the resulting insulation material, or a combination thereof, may be used to form a thermoformable nonwoven material, which indicates a nonwoven material that may be formed with a broad range of densities and thicknesses and that contains a thermoplastic and/or thermoset binder. The thermoformable nonwoven material may be heated and thermoformed into a specifically shaped thermoformed product. The nonwoven material may have a varying thickness (and therefore a varied or non-planar profile) along the length of the material. Areas of lesser thickness may be adapted to provide controlled flexibility to the insulation material, such as to provide an area that is folded (to fit within the hollow cavity to be insulated) or otherwise shaped, such as to form a corner or angled portion (e.g., to serve as the vertex between two thicker portions of the material) to allow the insulation material to be shaped. The insulation material may be shaped (e.g., by folding, bending, thermoforming, molding, and the like) to produce a box-like structure, a structure that can enclose the foam layer, or a structure generally matching the shape of the area to be insulated.

The insulation material therefore may be formed of a plurality of layers, including a foam material layer and a fibrous layer. The insulation material may include two or more fibrous layers. The insulation material may include one or more lofted layers, one or more skin layers, one or more facing layers, one or more foils, or a combination thereof. The one or more layers may be formed from metals, fibrous material, polymers, or a combination thereof. A skin may be formed by melting a portion of the layer by applying heat in such a way that only a portion of the layer, such as the top surface, melts and then hardens to form a generally smooth surface. A scrim may be applied or secured to one or more fibrous layers. The insulation material may include a plurality of layers, some or all of which serve different functions or provide different properties to the insulation material. The ability to combine layers of materials having different properties may allow the insulation material to be customized based on the application. The additional layers may function to provide additional insulation properties, protection to the foam material or other layers, IR reflective properties, conductive properties (or reduction of conductive properties), convective properties (or reduction of convective properties), structural properties, air flow resistive properties, acoustic absorption properties, or a combination thereof.

One or more insulation material layers may include one or more adhesive materials (e.g., as part of the fibers of the layer or as a separate element in or on the layer) for binding the fibers together, for binding layers together, or both. One or more insulation material layers may support a skin layer, other material layer, or both. One or more insulation material layers may provide heat resistance (e.g., if the insulation material is located in an area that is exposed to high temperatures). One or more insulation material layers may provide stiffness to the insulation material. Additional stiffness, structural properties, compression resistance, compression resiliency, or a combination thereof, may be provided by additional layers (or one or more layers in combination with the one or more fibrous matrix layers). One or more insulation material layers may provide flexibility and/or softness to the fibrous composite.

Any of the fibers or materials as discussed herein, especially with respect to the fibrous layer and/or processes of forming the fibrous layer, may also be employed to form or may be included within any of the additional layers of the insulation material, such as facing layers. Any of the materials described herein may be combined with other materials described herein (e.g., in the same layer or in different layers of the insulation material). The layers may be formed from different materials. Some layers, or all of the layers, may be formed from the same materials, or may include common materials or fibers. The type of materials forming the layers, order of the layers, number of layers, positioning of layers, thickness of layers, or a combination thereof, may be chosen based on the desired properties of each material (e.g., infrared reflectivity, insulation properties, conductive properties, convective properties), the insulation properties of the insulation material as a whole, the heat transfer properties of the insulation material as a whole, the desired air flow resistive properties of the insulation material as a whole, the desired weight, density and/or thickness of the insulation material (e.g., based upon the space available where the fibrous composite will be installed), the desired flexibility of the structure (or locations of controlled flexibility), or a combination thereof. The layers may be selected to provide varying orientations of fibers, which may reduce conductive heat transfer from one side of the insulation material to the other through the fibers, to reduce convective heat transfer for heat flow through the insulation material, or both. One or more insulation material layers may be any material known to exhibit sound absorption characteristics, insulation characteristics, or both. One or more insulation material layers may be at least partially formed as a web of material (e.g., a fibrous web). One or more fibrous composite layers may be formed from nonwoven material, such as short fiber nonwoven materials. One or more insulation material layers may be a porous bulk absorber (e.g., a lofted porous bulk absorber formed by a carding and/or lapping process). One or more insulation material layers may be formed by air laying. The insulation material may be formed into a generally flat sheet. The insulation material (e.g., as a sheet) may be capable of being rolled into a roll. The insulation material may be a continuous material so that longer lengths can be employed in a single piece. The insulation material (or one or more of the insulation material layers) may be an engineered 3D structure. It is clear from these potential layers that there is great flexibility in creating an insulation material that meets the specific needs of an end user, customer, installer, and the like.

The insulation material may be formed by alternating layers of foam material and fibrous layer material. A foam material may be sandwiched between two layers of fibrous material. Two layers of foam material may sandwich a fibrous material layer.

The one or more layers may be located on or attached to the fibrous layer. Layers may be directly attached to the fibrous layer. Layers may be attached indirectly to the fibrous layer (e.g., via an adhesive layer and/or another layer therebetween). For example, the insulation material may include one or more facing layers. Any or all of the layers, such as a facing layer or an intermediate layer (e.g., a layer between two fibrous layers or a layer between a fibrous layer and a foam material layer) may function to provide additional insulation, protection to the fibrous layer, infrared reflective properties, structural properties, or a combination thereof. The fibrous layer may be sandwiched between two (or more) facing layers. A layer (e.g., of a different composition) may be sandwiched between two fibrous layers. A facing layer, or an intermediate layer, may be generally coextensive with the side of the fibrous layer. The facing layer, or an intermediate layer, may instead cover or be attached to only a portion of a side of the fibrous layer. The facings or intermediate layers may include solid films, perforated films, solid foils, perforated foils, woven or nonwoven scrims, or other materials. For example, fibers forming the facing layer (e.g., if formed as a scrim) or the surface itself may be metallized to impart infrared reflectivity, thus providing an improved thermal insulating value to the overall insulation material.

The layers of material forming the insulation material (e.g., one or more facing layers) may be bonded together to create the finished insulation material. One or more layers may be bonded together by elements present in the layers. For example, the binder fibers in a fibrous layer may serve to bond the fibrous layer to another fibrous layer or to a foam material layer. The outer layers (i.e., the sheath) of bi-component fibers in one or more layers may soften and/or melt upon the application of heat, which may cause the fibers of the individual layers to adhere to each other and/or to adhere to the fibers of other layers. Layers may be attached together by one or more lamination processes. One or more adhesives may be used to join two or more layers. The adhesives may be a powder or may be applied in strips, sheets, or as a liquid or paste, for example.

The layers may be bonded together via an in-situ foaming process. For example, a foamable material may be applied on a fibrous layer or between two fibrous layers. The foamable material may be subjected to conditions causing it to foam (e.g., exposed to heat or gas), which may cause the foam and fibrous layers to become attached to each other.

The total thickness of the insulation material may depend upon the number and thickness of the individual layers. It is contemplated that the total thickness may be about 0.5 mm or more, about 1 mm or more, or about 1.5 mm or more. The total thickness may be about 300 mm or less, about 250 mm or less, or about 175 mm or less. For example, the thickness may be in the range of about 2 mm to about 155 mm or about 40 mm to about 70 mm (e.g., about 65 mm). It is also contemplated that some of the individual layers may be thicker than other layers. For example, the thickness of the foam material layer may be greater than the thickness of the fibrous layers (individually or combined). The total thickness of the fibrous layers may be greater than the total thickness of the foam material layers. The thickness may vary between the same types of layers as well. For example, two lofted layers in the insulation material may have different thicknesses. The insulation material may be tuned to provide desired insulation characteristics and/or more general broad band sound absorption by adjusting the specific air flow resistance and/or the thickness of any or all of the layers.

An insulation material or one or more layers thereof (e.g., nonwoven material) may be formed to have a thickness and density selected according to the required physical, insulative, and air permeability properties desired of the finished fibrous layer (and/or the insulation material as a whole). The layers of the insulation material may be any thickness depending on the application, location of installation, shape, fibers used (and the lofting of the fibrous layer layer), or other factors. The density of the layers of the insulation material may depend, in part, on the specific gravity of any additives incorporated into the material comprising the layer (such as nonwoven material), and/or the proportion of the final material that the additives constitute. Bulk density generally is a function of the specific gravity of the fibers and the porosity of the material produced from the fibers, which can be considered to represent the packing density of the fibers.

Insulation properties, acoustic properties, or both, of the insulation material (and/or its layers) may be impacted by the shape of the insulation material. The insulation material, or one or more of its layers, may be generally flat. The finished insulation material may be fabricated into cut-to-print two-dimensional flat parts for installation into the end user, installer, or customer's assembly. The insulation material may be formed into any shape. For example, the insulation material may be molded (e.g., into a three-dimensional shape) to generally match the shape of the area to which it will be installed or the cavity to which it is meant to insulate. The finished insulation material may be molded-to-print into a three-dimensional shape for installation into the end user, installer, or customer's assembly.

The insulation material may provide for sufficient insulation for the intended purpose. The insulation may have an R-value (° F.·ft²·h/Btu) of about 10 or more, about 12 or more, or about 15 or more. The ratio of R-value of foam material to fibrous material may be about 5:1 or less, about 4:1 or less, or about 3:1 or less. The ratio of R-value of foam material to fibrous material may be about 1:1 or more, about 1:1.5 or more, or about 1:2 or more. The R-value of the insulation material may be tuned by adjusting layer thickness, density, chemistry (using another type of fiber or foam), compression, additional layers (such as facing or foils for heat reflection). Therefore, the insulation material described herein in highly customizable depending on the needs.

The insulation material as described herein may also provide sound absorption characteristics. With fibrous materials, air flow resistance and air flow resistivity are important factors controlling sound absorption. Air flow resistance Air flow resistance is measured for a particular material at a particular thickness. The air flow resistance is normalized by dividing the air flow resistance (in Rayls) by the thickness (in meters) to derive the air flow resistivity measured in Rayls/m. ASTM standard C522-87 and ISO standard 9053 refer to the methods for determination of air flow resistance for sound absorption materials. Within the context of the teachings herein, air flow resistance, measured in mks Rayls, will be used to specify the air flow resistance; however other methods and units of measurement are equally valid. Within the context of the described teachings, air flow resistance and air flow resistivity can be assumed to also represent the specific air flow resistance, and specific air flow resistivity, respectively. Acoustic materials for sound absorption may have a relatively high air flow resistance to present acoustic impedance to the sound pressure wave incident upon the material. Air permeability should be managed to ensure predictable and consistent performance. This may be achieved through management of fiber sizes, types, and lengths, among other factors. A homogeneous, short fiber nonwoven textile may be desirable. In some applications, desirable levels of air permeability may be achieved by combining plural nonwoven materials of differing densities together to form a composite product.

Insulation, sound absorption, or both, can be tuned by adding one or more layers to the insulation material. These layers may have different levels of thermal conductivity. These layers may have different levels of specific air flow resistance. In a multi-layer insulation material, some layers may have a lower air flow resistance while other layers may have a higher air flow resistance. The layering of layers having different air flow resistive properties may produce a multi-impedance acoustic mismatched profile through the entire insulation material, which provides improved noise reduction capability of the insulation material. Therefore, the layers (or skins) may be arranged so that a layer (or skin) of higher specific air flow resistance is joined to, or formed on, or is adjacent to one or more layers of a different specific air flow resistance (e.g., a lower air flow resistance).

A low density fibrous material, which may be one or more of the insulation material layers, may be designed to have a low density, with a finished thickness of about 1.5 mm or more, about 4 mm or more, about 5 mm or more, about 6 mm or more, or about 8 mm or more. The finished thickness may be about 350 mm or less, about 250 mm or less, about 150 mm or less, about 75 mm or less, or about 50 mm or less. The fibrous material, which may be one or more of the insulation material layers, may be formed as a relatively thick, low density nonwoven, with a bulk density of 10 kg/m³ or more, about 15 kg/m³ or more, or about 20 kg/m³ or more. The thick, low density nonwoven may have a bulk density of about 200 kg/m³ or less, about 100 kg/m³ or less, or about 60 kg/m³ or less. The fibrous material (e.g., serving as one or more insulation material layers) thus formed may have an air flow resistivity of about 400 Rayls/m or more, about 800 Rayls/m or more, or about 100 Rayls/m or more. The fibrous composite material may have an air flow resistivity of about 200,000 Rayls/m or less, about 150,000 Rayls/m or less, or about 100,000 Rayls/m or less. Low density fibrous composite materials may even have an air flow resistivity of up to about 275,000 Rayls/m.

Additional sound absorption may also be provided by a skin or facing layer on the fibrous layer (e.g., by an in-situ skinning process or by the addition of a scrim layer). A skin or facing layer of the fibrous layer may provide additional air flow resistance (or air flow resistivity) to the fibrous composite. For example, the skin layer or scrim may have an air flow resistivity of about 100,000 Rayls/m or higher, about 275,000 Rayls/m or higher, 1,000,000 Rayls/m or higher, or even 2,000,000 Rayls/m or higher.

The insulation material may cover at least a portion of an item or area to be insulated. The insulation material may be secured at least partially within a channel or cavity (e.g., of a wall) to be insulated. The insulation material may be secured within an assembly, such as in a building. One or more insulation material layers may attach directly to a wall, surface of a substrate, surface of the area or channel to be insulated, or a combination thereof. The insulation material may be attached via a fastener, adhesive, or other material capable of securing the insulation material to a wall, substrate, or item to be insulated. The securing of the insulation material to itself or to another surface may be repositionable or permanent. The insulation material may include one or more fasteners, adhesives, or other known materials for joining a insulation material to a substrate, another portion of the insulation material, another insulation material, or a combination thereof. The fastener, adhesive, or other means of attachment may be able to withstand the elements to which it is exposed (e.g., temperature fluctuations). Fasteners may include, but are not limited to, screws, nails, pins, bolts, friction-fit fasteners, snaps, hook and eye fasteners, zippers, clamps, the like, or a combination thereof. Adhesives may include any type of adhesive, such as a tape material, a peel-and-stick adhesive, a pressure sensitive adhesive, a hot melt adhesive, the like, or a combination thereof. The fastener or adhesive, for example, that joins portions of the insulation material together may allow the insulation material to enclose or at least partially surround the item to be insulated and may hold the insulation material in that position. The insulation material may include one or more fasteners or adhesives to join portions of the insulation material to another substrate, such as the boundaries defining the cavity into which the insulation material is to be installed.

The one or more fasteners may be separately attached to or integrally formed with one or more layers of the insulation material. For example, the insulation material may include one or more tabs, projections, or a male-type fastener portion (e.g., at one end of the insulation material), and a corresponding opening or female-type fastener portion (e.g., on the opposing end of the insulation material) that can be received within the male-type fastener portion to hold the insulation material in a desired position. When the insulation material is to be formed into the desired shape (e.g., to surround the item to be insulated), the end of the insulation material can be attached to the opposing end, thereby forming an enclosure. For example, if the insulation material is wrapped around an item to be insulated, the ends of the insulation material can be secured together to hold the insulation material in position around the item to be insulated.

The insulation material may include a pressure sensitive adhesive (PSA). The PSA may be located on any part of the insulation material. For example, the PSA may be located on a surface of the insulation material that interfaces with a surface defining the wall or cavity to be insulated, which may allow the insulation material to be attached to the area to be insulated. The PSA may be located on a portion of the insulation material that contacts another portion of the insulation material (or another insulation material) so that the insulation material holds its desired shape and/or position. The PSA may be located between one or more layers of the insulation material (e.g., to join one or more layers). The PSA may be applied from a roll and laminated to at least a portion of the insulation material. A release liner may carry the PSA. Prior to installation of the insulation material, the release liner may be removed from the PSA to allow the insulation material to be adhered to a substrate, the item to be insulated, or to another portion of the insulation material, for example. It is contemplated that the release liner may have a high tear strength that is easy to remove to provide peel-and-stick functionality and to ease installation. The PSA may coat a portion of the insulation material. The PSA may coat an entire side or surface of the insulation material. The PSA may be coated in an intermittent pattern. The intermittent coating may be applied in strips or in any pattern, which may be achieved by hot-melt coating with a slot die, for example, although it can also be achieved by coating with a patterned roller or a series of solenoid activated narrow slot coating heads, for example, and may also include water and solvent based coatings, in addition to hot-melt coating. Where the PSA coating is applied intermittently, the spacing of the strips or other shape may vary depending on the properties of the insulation material. For example, a lighter fibrous material may need less PSA to hold the material in place. A wider spacing or gap between the strips can facilitate easier removal of the substrate, as a person can more readily find uncoated sections that allow an edge of the substrate to be lifted easily when it is to be peeled away to adhere the insulation material material to another surface. The pressure sensitive adhesive substance may be an acrylic resin that is curable under ultraviolet light, such as AcResin type DS3583 available from BASF of Germany. A PSA substance may be applied in a thickness of about 10 to about 150 microns, for example. The thickness may alternatively be from about 20 to about 100 microns, and possibly from about 30 to about 75 microns, for example. Other types of PSA substance and application patterns and thicknesses may be used, as well as PSA substances that can be cured under different conditions, whether as a result of irradiation or another curing method. For example, the PSA substance may comprise a hot-melt synthetic rubber-based adhesive or a UV-curing synthetic rubber-based adhesive. The PSA substance may be cured without UV curing. For example, the PSA could be a solvent or emulsion acrylic which may not require UV curing.

The insulation material as described herein also provides significant benefits over traditional materials. The fibrous material layers may provide damage protection to the foam material layers. The fibrous material layer may be drillable (e.g., without complete break), which allows for flexibility in the design or in installation. The insulation material may be perforated to allow for further customization of the dimensions of the material. The insulation material may have a soft outer surface that is compressible for fitting the insulator into the area to be insulated. This provides for ease of assembly and provides the ability to slide the insulator into a channel. The insulation material reduces surface noise (e.g., against walls and/or joints reducing rattling and squeaking). The insulation material provides for noise blockage by sound transmission loss within the wall layers. The insulation material is reusable, so it can be removed from wall compartments and reinstalled in another wall. The insulation material provides application location flexibility, so it can be used either at the plant making the walls or onsite at a construction zone. The insulation material may be nontoxic, may be safe to handle (even without gloves), or both. The insulation material may be non-shedding, which may provide structural integrity and/or increase health and safety for the installers of the material or anyone who may handle the material. The insulation material may reduce or eliminate the ability for mold and/or mildew to grow in the material. The insulation material may be compressible to provide a reduced thickness for transportation cost advantages. The insulation material may have thickness retention properties to maintain initial performance of thermal and/or acoustic characteristics. The insulation material may be thermoformable or have processable surfaces to provide better surface matching for functionality (e.g., to match the wall shape for a better fit and/or to maximize the area and thickness of the material relative to the space it is intended to fill).

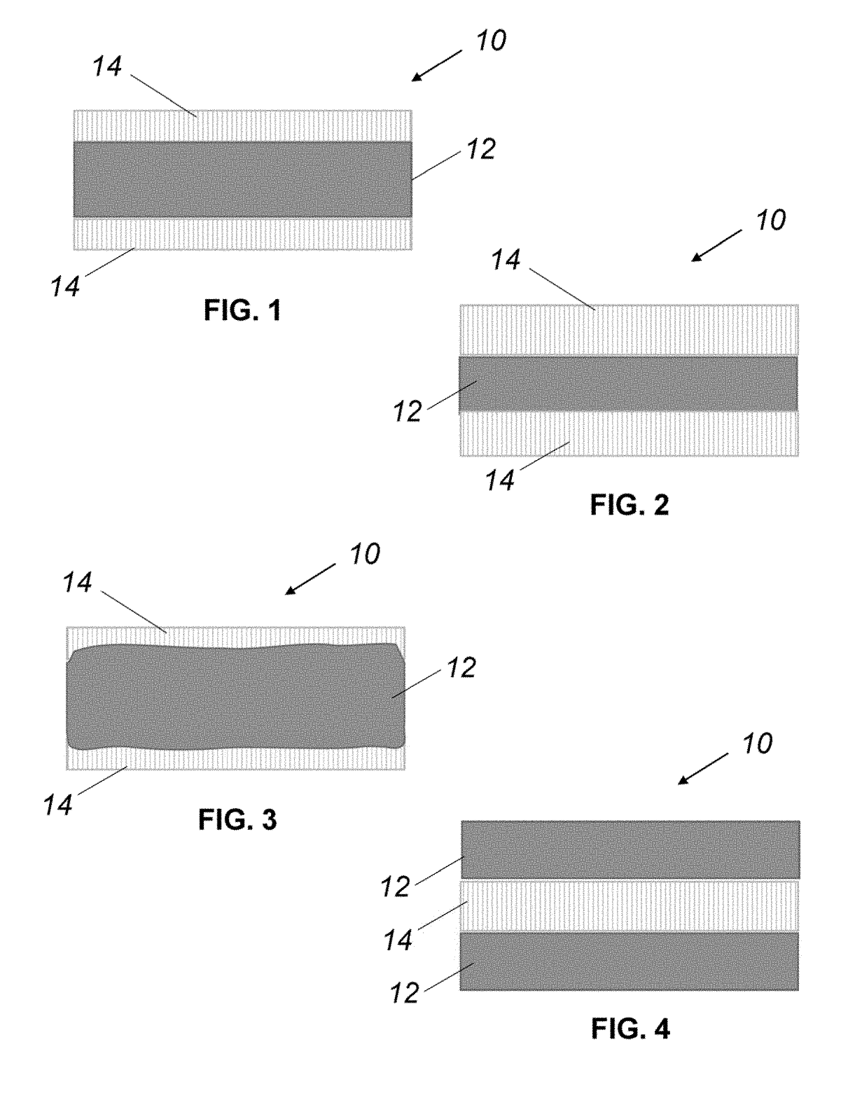

Turning now to the figures, FIGS. 1-4 illustrate exemplary insulators 10 in accordance with the present teachings. FIG. 1 is an insulator 10 having a foam material layer 12 sandwiched between two fibrous layers 14. The foam material layer 12 has a thickness that is greater than the combined thickness of both of the fibrous layers 14. FIG. 2 illustrates an insulator 10 having a foam material layer 12 sandwiched between two fibrous layers 14. The combined thickness of the fibrous layers 14 is greater than the thickness of the foam material layer. The insulators 10 of FIGS. 1 and 2 are prepared by laminating the fibrous layers 14 to the foam material layer 12, illustrated as a foam board.

FIG. 3 illustrates an insulator 10 having a foam layer 12 between two fibrous layers 14. The foam layer 12 is formed by an in-situ foaming process, such as by applying a foam formula onto one or both of the fibrous layers 14 and blowing the foam with a gas, such as carbon dioxide or hydrofluorocarbon gas. The foam material layer 12 has a thickness that is greater than the combined thickness of the fibrous layers 14, though the present teachings are not limited to such.

FIG. 4 illustrates an insulator 10 having a fibrous layer 14 sandwiched between two foam material layers 12. The thickness of one foam material layer 12 is greater than the thickness of the fibrous layer 14 (though not limited to this). The fibrous layer 14 can be laminated to one or both of the foam material layers 12, illustrated here as foam boards.

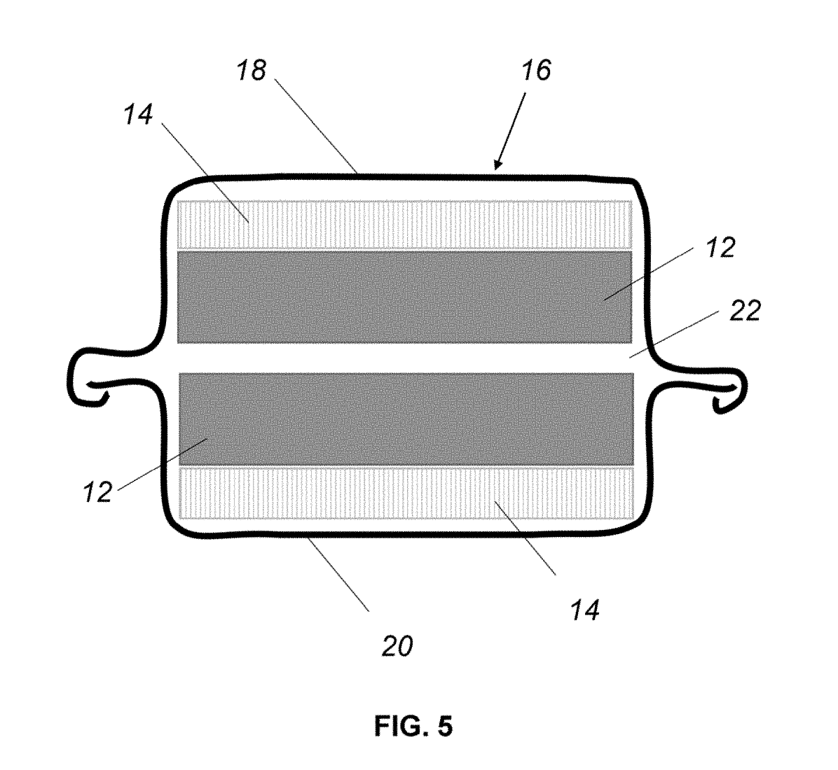

FIG. 5 illustrates a clamshell structure 16 having a first shell 18 and a second shell 20, defining a hollow cavity 22. Insulation material is positioned within the hollow cavity 22, with fibrous layers 14 located adjacent the first shell 18 and second shell 20 and two foam material layers 12 facing each other. The fibrous layers 14 may be laminated to the foam material layers 12. Each laminated insulator made up of a fibrous layer 14 and a foam material layer 12 may be attached to or positioned within the shells, and the shells can be snapped together or otherwise secured together like a clamshell.

Though not shown, it is contemplated that any of the insulators as shown herein may have one or more facing layers. For example, a facing layer or scrim may be positioned on an outer surface of a fibrous layer, facing away from the foam material layer.

### ILLUSTRATIVE EXAMPLES

The following examples are provided to illustrate the disclosed layered insulation material and layers thereof, but are not intended to limit the scope thereof.

### Example 1

Five samples are prepared in accordance with Table 1. All built-up sets are given an apparent density based on a 12″×12″ size.

TABLE 1

| Sample | Description |
|---|---|
| 1 | Nonwoven material having a density of 250 gsm and a |
| | thickness of 10 mm with a scrim that faces the hot plate. |
| 2 | Two nonwoven material layers, each having a density of |
| | 250 gsm and a thickness of 10 mm, on opposite sides of a 2″ |
| | laminated foil-faced PIR foam board to form a 4-layer |
| | sandwich composite. The scrims of the nonwoven material |
| | layers face out toward the apparatus test plates. There is |
| | slight compression on the nonwoven material layers, as the |
| | test gap is 65 mm. |
| 3 | Nonwoven material having a density of 500 gsm and a |
| | thickness of 10 mm with a scrim that faces the hot plate. |
| 4 | Two nonwoven material layers, each having a density of |
| | 500 gsm and a thickness of 10 mm, on opposite sides of a 2″ |
| | laminated foil-faced PIR foam board to form a 4-layer |
| | sandwich composite. The scrims of the nonwoven material |
| | layers face out toward the apparatus test plates. There is |
| | slight compression on the nonwoven material layers, as the |
| | test gap is 65 mm. |
| 5 | Two nonwoven material layers, each having a density of |
| | 1200 gsm and a thickness of 22 mm, on opposite sides of a |
| | 1″ foil-faced PIR foam board to form a 3-layer sandwich |
| | composite. There is slight compression on the nonwoven |
| | material layers, as the test gap is 65 mm. |

The samples are allowed to condition at standard laboratory conditions of 72±4° F. and 50±5% relative humidity for at least 40 hours prior to testing. The thermal resistance testing was conducted using ASTM Standard C518, “Standard Test Method for Steady-State Thermal Transmission Properties by Means of the Heat Flow Meter Apparatus” as a procedural guide.

The specimens were placed in the heat flow meter in a horizontal position, and steady-state heat flux measurements were made at a mean temperature of approximately 72.5° F. using a hot (top plate) face temperature of approximately 97.5° F. and a cold face (bottom plate) temperature of approximately 47.5° F. The heat flux is in the downward directions (hot plate to cold plate). Specimen thermal resistance and thermal conductivity were determined by comparing the heat flux measurements of the specimen to measurements made on a known Standard Reference Material. Resistance values obtained from the Heat Flow Meter are best utilized for homogenous specimens. The test results are provided in Table 2 and Table 3 below.

TABLE 2

| | Units | Sample 1 | Sample 2 | Sample 3 |
|---|---|---|---|---|
| SAMPLE PROPERTIES: | | | | |
| Thickness | cm | 1.4856 | 6.9429 | 1.1596 |
| | inches | 0.585 | 2.733 | 0.457 |
| Density | kg/m³ | 31.82 | 35.15 | 58.93 |
| | pcf | 1.99 | 2.19 | 3.68 |
| Mass Change During | Initial, g | 31.96 | 226.18 | 55.34 |
| Conditioning | Prior to test, g | 31.95 | 226.94 | 55.35 |
| | % of cond. | −0.03 | 0.33 | 0.02 |
| | mass | | | |
| Mass Change During | Prior to test, g | 31.95 | 226.94 | 55.35 |
| Testing | After test, g | 31.93 | 226.80 | 55.35 |
| | % of cond. | −0.06 | −0.06 | 0.00 |
| | Mass | | | |
| TEST CONDITIONS: | | | | |
| Temperature Gradient | K/m | 1822.37 | 415.41 | 2394.62 |
| | ° F./in | 83.32 | 18.99 | 109.48 |
| Mean Temperature | ° C. | 22.91 | 22.27 | 22.74 |
| | ° F. | 73.24 | 72.09 | 72.93 |
| Temperature Range | ° C. | 27.07 | 28.84 | 27.77 |
| (Delta) | ° F. | 48.73 | 51.91 | 49.99 |
| Test Time | hr:min:sec | 0:11:38 | 0:23:56 | 0:32:40 |
| RESULTS: | | | | |
| Heat Flux | W/m² | 774 | 119 | 924 |
| | Btu/(h · ft²) | 34 | 5 | 40 |
| Thermal Conductivity | W/m · K | 0.03883 | 0.02786 | 0.03621 |
| | Btu · in/(h · ft² · ° F.) | 0.26921 | 0.19315 | 0.25104 |
| Thermal Conductance | W/m² · K | 2.614 | 0.401 | 3.123 |
| | Btu/(h · ft² · ° F.) | 0.460 | 0.071 | 0.550 |
| Thermal Resistivity | m · K/W | 25.8 | 35.9 | 27.6 |
| | ° F. · ft² · h/Btu/in | 3.71 | 5.18 | 3.98 |
| Thermal Resistance, | m² · K/W | 0.38 | 2.49 | 0.32 |
| “R” Value | ° F. · ft² · h/Btu | 2.17 | 14.15 | 1.82 |

TABLE 3

| | Units | Sample 4 | Sample 5 |
|---|---|---|---|
| SAMPLE PROPERTIES: | | | |
| Thickness | cm | 6.977 | 6.521 |
| | inches | 2.747 | 2.567 |
| Density | kg/m³ | 41.88 | 49.41 |
| | pcf | 2.61 | 3.08 |
| Mass Change During | Initial, g | 270.75 | 298.47 |
| Conditioning | Prior to test, g | 271.60 | 298.96 |
| | % of cond. | 0.31 | 0.16 |
| | mass | | |
| Mass Change During | Prior to test, g | 271.60 | 298.96 |
| Testing | After test, g | 271.59 | 298.90 |
| | % of cond. | 0.00 | −0.02 |
| | Mass | | |
| TEST CONDITIONS: | | | |
| Temperature Gradient | K/m | 404.31 | 431.67 |
| | ° F./in | 18.49 | 19.74 |
| Mean Temperature | ° C. | 22.19 | 22.22 |
| | ° F. | 71.94 | 72.00 |
| Temperature Range | ° C. | 28.21 | 28.15 |
| (Delta) | ° F. | 50.78 | 50.67 |
| Test Time | hr:min:sec | 0:44:36 | 0:28:01 |
| RESULTS: | | | |
| Heat Flux | W/m² | 118 | 149 |
| | Btu/(h · ft²) | 5 | 6 |
| Thermal Conductivity | W/m · K | 0.02777 | 0.03282 |
| | Btu · in/(h · ft² · ° F.) | 0.19253 | 0.22754 |
| Thermal Conductance | W/m² · K | 0.398 | 0.503 |
| | Btu/(h · ft² · ° F.) | 0.070 | 0.089 |
| Thermal Resistivity | m · K/W | 36.0 | 30.5 |
| | ° F. · ft² · h/Btu/in | 5.19 | 4.39 |
| Thermal Resistance, | m² · K/W | 2.51 | 1.99 |
| “R” Value | ° F. · ft² · h/Btu | 14.26 | 11.28 |

### Example 2

A three-layer sample is prepared, with a 38 millimeter thick poiyisocyanurate board sandwiched between two nonwoven fibrous layers, each fibrous layer having a thickness of 15 millimeters and a surface density of 250 gsm. Scrim layers on the nonwoven fibrous layers face outwardly.

The sample is allowed to condition at standard laboratory conditions of 72±4° F. and 50±5% relative humidity for at least 40 hours prior to testing. The thermal resistance testing is conducted using ASTM Standard C518, “Standard Test Method for Steady-State Thermal Transmission Properties by Means of the Heat Flow Meter Apparatus” as a procedural guide. The specimen is placed in the heat flow meter in a horizontal position, and steady-state heat flux measurements are made at a mean temperature of approximately 72.5° F. using a hot (top plate) face temperature of approximately 97.5° F. and a cold face (bottom plate) temperature of approximately 47.5° F. The heat flux is in the downward direction (hot plate to cold plate). Specimen thermal resistance and thermal conductivity are determined by comparing the heat flux measurements of the specimen to measurements made on a known Standard Reference Material. Resistance values obtained from the Heat Flow Meter are best utilized for homogenous specimens. The test results are provided in Table 4. Estimated uncertainty is ±5% or less.

TABLE 4

| | Units | #1 |
|---|---|---|
| SAMPLE PROPERTIES: | | |
| Thickness | cm | 6.513 |
| | inches | 2.564 |
| Density | kg/m³ | 27.83 |
| | pcf | 1.74 |
| Mass Change During | Initial, g | 167.80 |
| Conditioning | Prior to test, g | 168.03 |
| | % of cond. | 0.14 |
| | mass | |
| Mass Change During | Prior to test, g | 168.03 |
| Testing | After test, g | 167.96 |
| | % of cond. | −0.04 |
| | Mass | |
| TEST CONDITIONS: | | |
| Temperature Gradient | K/m | 435.49 |
| | ° F./in | 19.91 |
| Mean Temperature | ° C. | 22.03 |
| | ° F. | 71.65 |
| Temperature Range | ° C. | 28.36 |
| (Delta) | ° F. | 51.05 |
| Test Time | hr:min:sec | 0:58:12 |
| RESULTS: | | |
| Heat Flux | W/m² | 134.47 |
| | Btu/(h · ft²) | 5.75 |
| Thermal Conductivity | W/m · K | 0.02967 |
| | Btu · in/(h · ft² · ° F.) | 0.20570 |
| Thermal Conductance | W/m² · K | 0.456 |
| | Btu/(h · ft² · ° F.) | 0.080 |
| Thermal Resistivity | m · K/W | 33.70 |
| | ° F. · ft² · h/Btu/in | 4.86 |
| Thermal Resistance, “R” | m² · K/W | 2.20 |
| Value | ° F. · ft² · h/Btu | 12.46 |

Parts by weight as used herein refers to 100 parts by weight of the composition specifically referred to. Any numerical values recited in the above application include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32, etc. are expressly enumerated in this specification. For values which are less than one, one unit is considered to be 0.0001, 0.001, 0.01, or 0.1 as appropriate. These are only examples of what is specifically intended and all possible combinations of numerical values between the lowest value, and the highest value enumerated are to be expressly stated in this application in a similar manner. Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps. Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

What is claimed is:

1. An article comprising:
a. one or more foam material layers;
b. one or more nonwoven fibrous layers;
wherein the article is adapted to be used as insulation within a wall or hollow cavity.

2. The article of claim 1, wherein the one or more foam material layers is sandwiched between two nonwoven fibrous layers.

3. The article of claim 1, wherein the one or more nonwoven fibrous layers are sandwiched between two foam material layers.

4. The article of claim 1, wherein the article exhibits an R-value of about 12° F.·ft²·h/Btu or greater at a thickness of about 60 mm to about 70 mm.

5. The article of claim 1, wherein the one or more nonwoven fibrous layers are adapted to provide protection to the one or more foam material layers.

6. The article of claim 1, wherein the one or more nonwoven fibrous layers are compressible to fit within the wall or hollow cavity.

7. The article of claim 1, wherein the article is mold or mildew resistant.

8. The article of claim 1, wherein the article is non-shedding.

9. The article of claim 1, wherein the article is non-toxic.

10. The article of claim 1, wherein the article or one or more layers thereof is thermoformable to allow the article to be shaped to fit in an area to be insulated.

11. The article of claim 1, wherein the foam material layer is formed of a polyisocyanurate (PIR) board.

12. The article of claim 1, wherein the foam material layer is formed via a foam-in-place process after being applied to one or more of the fibrous layers.

13. The article of claim 1, wherein the nonwoven fibrous layer includes fibers selected from polyester (PET), polyacrylonitrile (PAN), oxidized polyacrylonitrile (Ox-PAN, OPAN, or PANOX), aramid, olefin, polyamide, imide, polyetherketone (PEK), polyetheretherketone (PEEK), Poly(ethylene succinate), polyether sulfonate (PES), mineral, ceramic, natural or another polymeric fiber.

14. The article of claim 1, wherein the fibrous layer includes bicomponent fibers.

15. The article of claim 1, wherein the fibrous layer is formed by distributing fibers via an air laying process.

16. The article of claim 1, wherein the fibrous layer is formed by distributing fibers via a carding and lapping process.

17. The article of claim 1, wherein the fibrous layer includes one or more additives selected from recycled waste, virgin (non-recycled) materials, binders, fillers (e.g., mineral fillers), adhesives, powders, thermoset resins, coloring agents, flame retardants, and longer staple fibers.

18. The article of claim 1, wherein the article includes one or more fasteners for securing the article within an area to be insulated, or for holding the article in a desired shape.

19. The article of claim 1, wherein the article includes one or more adhesives for securing the article within an area to be insulated, or for holding the article in a desired shape.

20. The article of claim 1, wherein the article is flame and smoke retardant, to comply to architectural and building codes.
